(19) United States
(12) Patent Application Publication
(10) Pub. No.: US 2024/0294692 A1
(43) Pub. Date: Sep. 5, 2024

(54) POLYISOCYANURATE PLASTICS WITH HIGH TRANSPARENCY

(71) Applicant: SIKA TECHNOLOGY AG, Baar (CH)

(72) Inventors: Michael HUBER, Zürich (CH); Steffen KELCH, Oberengstringen (CH); Urs BURCKHARDT, Zürich (CH); Michael SCHLUMPF, Stallikon (CH)

(73) Assignee: SIKA TECHNOLOGY AG, Baar (CH)

(21) Appl. No.: 18/578,412

(22) PCT Filed: Jul. 19, 2022
(86) PCT No.: PCT/EP2022/070256

§ 371 Date: Jan. 11, 2024

(30) Foreign Application Priority Data
Jul. 23, 2021 (EP) 21187513.3

(51) Int. Cl. C08G 18/02; C08G 18/16

(52) U.S. Cl. CPC C08G 18/022; C08G 18/168

(57) ABSTRACT

A process for producing a polyisocyanurate plastic includes the following steps: providing a polyisocyanate composition which includes at least one oligomeric polyisocyanate, adding at least one tertiary organic phosphine catalyst to the polyisocyanate composition, and catalytically trimerizing the isocyanate functionalities of the polyisocyanate composition using the at least one tertiary organic phosphine as trimerization catalyst, whereby the at least one tertiary organic phosphine catalyst includes trioctylphosphine and the at least one tertiary organic phosphine catalyst is used with a proportion of 0.005-0.85 wt. % with respect to the weight of the polyisocyanate composition. The process can be performed at ambient temperature under ambient air and humidity conditions and yields polyisocyanurate plastics with exceptionally high transparency for light in the visible spectrum.

### TECHNICAL FIELD

The invention relates to a process for producing a polyisocyanurate plastic comprising the steps of a) providing a polyisocyanate composition which comprises at least one oligomeric polyisocyanate, b) adding at least one tertiary organic phosphine catalyst to the polyisocyanate composition and c) catalytically trimerizing the isocyanate functionalities of the polyisocyanate composition using the at least one tertiary organic phosphine as trimerization catalyst. Another aspect of the invention is directed to the use of at least one tertiary organic phosphine as a catalyst in a catalytic trimerization of a polyisocyanate composition and for controlling the optical transparency in the visible spectrum of a polyisocyanurate plastic obtainable by the catalytic trimerization. Furthermore, the invention is directed to a polyisocyanurate plastic obtainable by the inventive process and products comprising or consisting of polyisocyanurate plastics.

### BACKGROUND ART

Transparent plastic materials are widely used for example as clear coats, films, receptacles, packaging materials, encapsulation materials, optical fibers or lenses, light diffusers, and also as adhesives. Transparent materials typically have a high transmission ratio towards visible light, i.e., from 400 to 800 nm.

Since polymers with polyisocyanurate structural units are known for their good mechanical and thermal properties, various attempts have been made to produce transparent plastic materials based on this kind of polymers. Polymers with polyisocyanurate crosslinks are typically produced by catalytic conversion of monomeric or oligomeric isocyanates. The polyisocyanurate formation is normally triggered by increasing the temperature 50-100° C. above room temperature and is further promoted significantly by the high reaction enthalpy produced in the exothermic catalytic process.

In this regard, WO 2018/041800 A1 (Covestro) describes for example a process for producing transparent polyisocyanurate plastics, comprising the following steps: a) providing a polyisocyanate composition which comprises oligomeric polyisocyanates and is low in monomeric diisocyanates (not more than 20% by weight of monomeric diisocyanates), b) adding a tertiary organic phosphine trimerization catalyst and c) trimerization of the isocyanate functionalities in the polyisocyanate composition using the tertiary organic phosphine as catalyst. The so produced plastic material can be used e.g., as coatings, films, semi-finished products and moldings.

However, many of the transparent polyisocyanurate plastics known so far feature a limited transparency, require demanding reaction conditions with respect to starting temperature and exclusion of air and/or are based on catalysts, which are problematic because of their environmental, health and safety (EHS) properties.

WO 2019/219603 A1 (Covestro) discloses an improved process for producing polyisocyanurate plastics especially suitable for Prepreg applications, involving a controlled two-step curing mechanism by two different catalysts, in particular a combination of a tertiary organic phosphine and a metal salt such as potassium acetate. The thus obtained plastics are not particularly transparent but possess improved mechanical properties and can be processed more efficiently.

One particular potential application for transparent polyisocyanurate plastics could be esthetic finishing of wood surfaces in furniture and decorative wooden objects and the production of so-called river tables. River tables are traditionally produced by filling and partially coating of irregularly shaped wooden tabletop precursors having large holes or grooves or their surface using a transparent and optionally colored resin, thus creating a flat tabletop surface having wooden and visible resin parts, often optically appearing like a landscape with a river. The resins used to create these river tables are most commonly hard, transparent two-component epoxy resins, as they possess the required mechanical and esthetic properties. However, epoxy resins intrinsically have certain disadvantages. Their curing is very exothermic, which can create bubbles, shrinkage and yellowing especially when applied in thick layers or to fill large cavities. Furthermore, depending on the amine hardeners used, they may tend to blush and to form irregular surfaces and normally require surface finishing such as grinding in order to satisfy customer requirements. Lastly, epoxy resin compositions with amine hardeners are problematic in terms of EHS concerns and require careful handling, especially by laymen. Therefore, an easy-to-use polyisocyanurate resin with high transparency that could replace the epoxy resins in this application and not having their disadvantages would be highly desirable.

Thus, there is still a need for new and improved solutions that overcome the aforementioned disadvantages as far as possible and provide an energy saving and environmentally friendly curing process.

### DISCLOSURE OF THE INVENTION

It is an object of the present invention to provide improved solutions for preparing transparent polyisocyanurate plastics under normal ambient conditions. Thereby, preferably, the solutions should allow for preparing polyisocyanurate plastics with a defined transparency for light in the visible wavelength range. In particular, the polyisocyanurate plastics should have an excellent transparency and a concentration of optically visible defects as low as possible. At the same time, the plastics should be obtainable in a procedure performed at room temperature and under exposure to ambient air having common relative humidity that is as simple and safe as possible. Furthermore, the produced plastics should also be mechanically stable and resistant to heat, combined heat and humidity and ultraviolet radiation.

Surprisingly, it has been found that these objectives can be achieved with the process, the polyisocyanurate plastic, and the use according to independent claims 1, 12 and 15.

Specifically, in a first aspect the present invention is related to a process for producing a polyisocyanurate plastic, comprising the following steps:
a) providing a polyisocyanate composition which comprises at least one oligomeric polyisocyanate,
b) adding at least one tertiary organic phosphine catalyst to the polyisocyanate composition,
c) catalytically trimerizing the isocyanate functionalities of the polyisocyanate composition using the at least one tertiary organic phosphine as trimerization catalyst,
   whereby the at least one tertiary organic phosphine catalyst comprises trioctylphosphine and the at least one tertiary organic phosphine catalyst is used with a proportion of 0.005-0.85 wt. % with respect to the weight of the polyisocyanate composition.

Trioctylphosphine has the molecular formula C₂₄H₅₁P and in particular is meant to be tri-n-octylphosphine or [CH₃(CH₂)₇]3P, respectively.

When compared to other tertiary organic phosphine catalyst, such as e.g. tri-n-butyl-phosphine, trioctylphosphine is rather easy to handle and significantly less problematic with regard to environmental, health and safety properties (EHS). Especially, trioctylphosphine is much less problematic regarding bad odor generation.

As it turned out, when using the inventive catalyst with a proportion of 0.005-0.85 wt. %, in particular 0.4-0.7 wt. % with respect to the weight of the polyisocyanate composition, the transparency for light in the visible spectrum, i.e. for light with a wavelength from 400-800 nm, of the polyisocyanurate plastic obtainable by the trimerization process is greatly enhanced in an unexpected manner when compared to higher proportions, while lower proportions are not able to catalyze the curing process sufficiently.

Furthermore, it was surprisingly found that when using trioctylphosphine as a catalyst in a catalytic trimerization of a polyisocyanate composition, which comprises oligomeric polyisocyanates, the optical transparency for light in the visible spectrum of the polyisocyanurate plastic obtainable by the catalytic trimerization can be controlled by the proportion of the catalyst over a rather wide range.

Nevertheless, with trioctylphosphine it is possible to prepare polyisocyanurate plastics that: show a low density of optical defects (essentially blister-free), are highly beneficial with regard to mechanical properties (e.g. stiffness, scratch resistance), preferably feature a high Tg (glass transition temperature), are stable against ultraviolet radiation, in preferred embodiments are highly heat resistant, resistant against combined heat and humidity, feature a good processability, and show a good adhesion as well as a high lap-shear strength.

Also, thanks to the inventive method, the polyisocyanurate plastics can be produced under ambient conditions and at rather low costs. Without being bound by theory, it is believed that due to the combination of the specific catalyst added in step b) in the specified amounts and the oligomeric polyisocyanates of the polyisocyanate composition provided in step a) is less sensitive to humidity, which allows for conducting step c) under ambient temperature and humidity conditions.

Furthermore, the material does not cure with problematic exothermicity even in large or thick layers or volumes, as it is the case with epoxy-based compositions.

Particularly preferred embodiments are outlined throughout the description and the dependent claims.

### Ways of Carrying Out the Invention

A first aspect of the present invention is directed to a process for producing a polyisocyanurate plastic, comprising the following steps:
a) providing a polyisocyanate composition which comprises at least one oligomeric polyisocyanate,
b) adding at least one tertiary organic phosphine catalyst to the polyisocyanate composition,
c) catalytically trimerizing the isocyanate functionalities of the polyisocyanate composition using the at least one tertiary organic phosphine as trimerization catalyst,
   whereby the at least one tertiary organic phosphine catalyst comprises trioctylphosphine and the at least one tertiary organic phosphine catalyst is used with a proportion of 0.005-0.85 wt. % with respect to the weight of the polyisocyanate composition.

In the field of optics, “transparency” is the physical property of a material to allow light of a certain wavelength to pass through the material. If a material is fully transparent, the intensity of incident light equals the intensity of the light transmitted through the material. Transparency in the visible spectrum can e.g. be determined with a UV/VIS absorption spectrometer. Most spectrometers display absorbance on the vertical axis, and the typically observed range is from 0 (100% transmittance) to 2 (1% transmittance). The term “absorbance” is the common logarithm of the ratio of the intensity of incident light to the intensity of the light transmitted through the material.

A “plastic” is a synthetic or semi-synthetic material based on polymers as a main component. In particular, the plastic is a thermoset. Especially the plastic is dimensionally stable and/or solid at room temperature. The term “polyisocyanurate plastic” is meant to be a plastic comprising or consisting of polyisocyanurate crosslinks.

The prefix “poly” in substance names such as “polyisocyanate” in the present document indicates that the respective substance formally contains more than one of the respective functional group per molecule, resp. repetition unit, that occurs in its name.

In the present document the term “polymer” firstly encompasses a group of macromolecules that are chemically uniform but differ in the degree of polymerization, molecular weight, and chain length, said group having been produced by a “poly” reaction (polymerization, polyaddition, polycondensation).

“Polyisocyanates” are substances comprising two or more free isocyanate groups in the molecule. A polyisocyanate with exactly two isocyanate groups can be called a diisocyanate. Polyisocyanates encompass monomeric as well as oligomeric polyisocyanates.

“Oligomeric polyisocyanates” are meant to be polyisocyanates which have been obtained by reacting at least two monomeric polyisocyanates, especially via a dimerization and/or trimerization reaction of the isocyanate groups. Thereby uretdion, isocyanurate and/or biuret units can be formed for example. However, oligomeric polyisocyanates still have at least two free isocyante groups. Processes for preparing oligomeric polyisocyanates are known to those skilled in the art. Furthermore, oligomeric polyisocyanates are commercially available from different suppliers, e.g. in the form of hardener components for polyurethane coatings and adhesives. Suitable oligomeric polyisocyanates are commercially available, for example under the trade name range Desmodur® N from Covestro, for example Desmodur® N 3600 or Desmodur® N 3300.

The polyisocyanate composition provided in step a) already comprises the at least one oligomeric polyisocyanate before starting the trimerization reaction in step c).

In particular, the at least one oligomeric polyisocyanate represents the main component of the polyisocyanate composition provided in step a). The main component is meant to be the component with the largest proportion of all components comprised in the provided polyisocyanate composition.

In particular, the polyisocyanate composition provided in step a) comprises at least 80 wt. %, in particular at least 85 wt. %, especially at least 90 wt. %, preferably, at least 95 wt. %, particularly preferred at least 98 wt. %, for example at least 99 wt. %, based on the weight of the polyisocyanate composition, of oligomeric polyisocyanates. These proportions refer to the polyisocyanate composition before starting the trimerization reaction in step c).

According to a special implementation, the polyisocyanate composition provided in step a) entirely consists of oligomeric polyisocyanates.

Especially a proportion of monomeric polyisocyanates in the polyisocyanate composition provided in step a) is at most 20 wt. %, especially at most 10 wt. %, preferably at most 5 wt. %, particularly at most 1 wt. %, more preferred at most 0.5 wt. % or at most 0.1 wt. %, most preferably less than 0.1 wt. %, based on the weight of the polyisocyanate composition.

Thus, the polyisocyanate composition provided in step a) may comprise at least one monomeric polyisocyanate but the proportion should be kept at a low level.

According to a special implementation, the polyisocyanate composition provided in step a) comprises at most 0.5 wt. %, preferably less than 0.1 wt.-%, based on the weight of the polyisocyanate composition.

In practice, removal of unwanted excess monomers can be achieved by distillation or extraction, preferably by thin-film distillation under high vacuum or by extraction with suitable solvents that are inert toward isocyanate groups. Such processes are known to the person skilled in the art.

Preferably, the at least one oligomeric polyisocyanate has an uretdione, isocyanurate, allophanate, biuret, iminooxadiazinedione and/or oxadiazinetrione structure. Particularly preferred are biuret, allophanate, isocyanurate and/or iminooxadiazinedione structures. Especially preferred are isocyanurate structures.

According to a highly preferred embodiment, the at least one oligomeric polyisocyanate consists to an extent of at least 50 mol. %, preferably at least 60 mol. %, more preferably at least 70 mol. %, preferably at least 80 mol. % or 90 mol. %, based on the sum total of all uretdione, isocyanurate, allophanate, biuret, iminooxadiazinedione and oxadiazinetrione structures present in the polyisocyanate composition, of an isocyanurate structure.

Especially, the at least one oligomeric polyisocyanate comprises one or more oligomeric polyisocyanates which are based on oligomers of diisocyanates.

In particular, the at least one oligomeric polyisocyanate comprises at least 70 wt. %, in particular at least 80 wt. %, especially at least 85 wt. %, preferably at least 95 wt. %, particularly preferred at least 98 wt. %, for example at least 99 wt. %, based on the weight of the polyisocyanate composition, having exclusively aliphatically and/or cycloaliphatically bonded isocyanate groups. Especially, the at least one oligomeric polyisocyanate has exclusively aliphatically and/or cycloaliphatically bonded isocyanate groups.

Especially the oligomers are based on butane-1,4-diisocyanate, pentane-1,5-diisocyanate, hexane-1,6-diisocyanate, 2,2,4 (or 2,4,4)-trimethylhexane-1,6-diisocyanate, isophorone diisocyanate, 4,4′-diisocyanatodicyclohexylmethane or mixtures thereof. Especially preferred are oligomers of 1,6-diisocyanatohexane.

In a highly preferred implementation, the at least one oligomeric polyisocyanate comprises or consists of a trimer of 1,6-diisocyanatohexane, in particular hexamethylene triisocyanate triisocyanurate.

In another highly preferred implementation, the at least one oligomeric polyisocyanate comprises or consists of a trimer of 1,5-diisocyanatopentane, in particular pentamethylene triisocyanate triisocyanurate.

According to another special implementation, the polyisocyanate composition comprises a mixture of at least two oligomeric polyisocyanates whereby the at least two oligomeric polyisocyanates differ in their chemical structure.

The oligomeric polyisocyanate composition provided in step a) and/or the at least one oligomeric polyisocyanate present therein preferably have a mean NCO functionality of 2.0 to 5.0, preferably of 2.3 to 4.5.

Further preferred, a content of isocyanate groups of the polyisocyanate composition is from 8-28 wt. %, especially 14-24 wt. %, based on the weight of the polyisocyanate composition.

Preparation processes for the oligomeric polyisocyanates having uretdione, isocyanurate, allophanate, biuret, iminooxadiazinedione and/or oxadiazinetrione structure in the polyisocyanate composition are described, for example, in J. Prakt. Chem. 336 (1994) 185-200, in DE 1 670 666, DE 1 954 093, DE 2 414 413, DE 2 452 532, DE 2 641 380, DE 3 700 209, DE 3 25 900 053 and DE 3 928 503 or in EP 0 336 205, EP 0 339 396 and EP 0 798 299.

Preferably, the at least one tertiary organic phosphine catalyst added in step b) consists to an extent of at least 80 wt. %, especially at least 90 wt. %, of the trioctylphosphine. More preferably, the at least one tertiary organic phosphine catalyst entirely consists of trioctylphosphine.

However, for special applications, further tertiary organic phosphine catalysts can be present, if desired.

However, it is preferred that no further catalysts other than tertiary organic phosphines are present in the composition, in particular no metal salts or metal complexes such as potassium acetate, as such compounds tend to decrease the transparency and impair the esthetic bulk and surface quality of the material, especially when the composition is cured under air atmosphere. Most preferably, the sole trimerization catalyst present in the polyisocyanate composition is trioctylphosphine.

Accordingly, in a very preferred embodiment of the process, the at least one tertiary organic phosphine catalyst consists of trioctylphosphine and no further catalyst or co-catalyst other than trioctylphosphine is added in step b) and/or present in step c).

The proportion of the at least one tertiary organic phosphine catalyst, especially the proportion of the trioctylphosphine, is preferably 0.1-0.85 wt. %, in particular 0.3-0.8 wt. %, further preferred 0.4-0.75 wt. %, more preferred 0.4-0.7 wt. %, especially 0.4-0.6 wt. %, with respect to the weight of the polyisocyanate composition.

Trioctylphosphine typically has sufficient solubility in the polyisocyanate composition with these proportions. Thus, trioctylphosphine can be used in pure form. However, it is also possible and may be preferred to use trioctylphosphine of technical grade (≥90% purity). In general, it is preferred that trioctylphosphine is liquid under ambient conditions and/or when it is added to the composition in step b). Optionally, trioctylphosphine can be added in step b) mixed with other substances, for example plasticizers, polyols, diluents, or other additives.

Optionally, however, trioctylphosphine and/or any other catalyst can also be used dissolved in a suitable organic solvent to improve their compatibility. Suitable catalyst solvents are, for example, solvents that are inert toward isocyanate groups and do not alter the optical properties of the resulting composition, e.g. by exhibiting poor compatibility and/or by exhibiting a different density.

It is also possible to use additives such as e.g. fillers, UV stabilizers, flame retardants, antioxidants, mold release agents, water scavengers, defoamers, levelling agents, rheology additives, flame retardants, colorants, and/or pigments in either step a) or b) or both of the process. These additives typically are present in an amount of 0.001-10 wt. %, preferably 0.1-5 wt. %, based on the weight of the polyisocyanate composition.

Preferably, step c) is effected at a temperature from 0-100° C., especially 1-80° C., in particular 5-40° C., in particular 10-35° C., especially 15-30° C., and/or at a relative air humidity of at least 20%, especially at least 30%, in particular at least 40%.

Especially preferred, step c) is conducted under ambient conditions, in particular. under influence of ambient air containing common levels of moisture and oxygen. In particular, step c) is conducted in an air and/or N₂ atmosphere.

Most preferred step c) is conducted under ambient conditions and in an air and/or N₂ atmosphere.

Preferably, the catalytic trimerization in step c) is conducted at least up to a conversion level at which at least 80%, especially at least 90% of the isocyanate groups originally present in the polyisocyanate composition have been reacted. The percentage of isocyanate groups that have been reacted can be determined by comparison of the content of isocyanate groups in the original polyisocyanate composition with the content of isocyanate groups in the reaction product, for example by the comparison of the intensity of the isocyanate band at about 2270 cm⁻¹ by means of infrared spectroscopy.

A further aspect of the present invention is related to a polyisocyanurate plastic obtainable by the process as described above.

Another aspect is directed to a coating, a film, a semi-finished product, an optical component or a molding or an adhesive comprising or consisting of a polyisocyanurate plastic obtainable by the process as described above.

For production of films or coatings, for example lacquers, a mixture of the polyisocyanate composition and the catalyst can be applied, for example, by spraying, painting, dipping, flow-coating, or with the aid of brushes, rollers or coating bars, in one or more layers, directly to any substrates, for example metal, wood, glass, stone, ceramic materials, concrete, hard and flexible plastics, textiles, leather and paper, and these can optionally also be provided with standard primers prior to the coating.

For production of solid components, for example semi-finished products or moldings, the mixture of the polyisocyanate composition and the catalyst containing component can be introduced into open or closed molds, for example, by simple manual pouring, or with the aid of suitable machinery, for example the low-pressure or high-pressure machinery which is standard in polyurethane technology.

The inventive coatings, films, semi-finished products, optical components or moldings inter alia can be used in the fields of building and construction, automotive, industry and consumer goods, sport articles, packaging, healthcare, especially medical products and optical lenses.

A preferred application of the polyisocyanurate plastic obtainable by the process as described above is the esthetic finishing of wood surfaces in furniture and decorative wooden objects and the production of so-called river tables, wherein the plastic forms a coating or filler resin on the surface or within gaps or cavities of these objects. It has been found that the polyisocyanurate plastic obtainable by the process as described above is highly suitable for this purpose, as it possesses exceptional transparency and ideal mechanical properties, cures easily under ambient conditions and without excessive exothermicity, and can be applied in thick layers or large volumes without causing bubbles or optical defects. Furthermore, it forms a homogeneous, smooth surface. With these properties the polyisocyanurate plastic obtainable by the process as described above has a high potential to replace epoxy resins used for this purpose and eliminates the problems associated with them.

Accordingly, a further aspect of the present invention is related to the use of a polyisocyanurate plastic obtainable by the process as described above as coating and filling resin for the esthetic finishing of wood surfaces in furniture and decorative wooden objects and the production of river tables.

A further aspect of the present invention is related to the use of trioctylphosphine as a catalyst in a catalytic trimerization of a polyisocyanate composition, which comprises oligomeric polyisocyanates, and for controlling, especially increasing, the optical transparency in the visible spectrum of a polyisocyanurate plastic obtainable by the catalytic trimerization.

Thereby, the polyisocyanate composition, the oligomeric polyisocyanates are defined as described above in connection with the inventive method.

“Controlling the optical transparency” means that the transparency of the polyisocyanurate plastic can be set in a targeted manner. As surprisingly found, it is possible to control the transparency of the polyisocyanurate plastic simply by the proportion of trioctylphosphine over a rather wide range. Specifically, the absorbance for light having a wavelength of for example 600 nm can be adjusted from 0.04 (for 0.5 wt. % trioctylphosphine) to 2.8 (for 4 wt. % trioctylphosphine). A similar behavior can be observed with light having other wavelengths within the range of 400-800 nm as well. Thereby, when choosing the concentration to a value of below 0.8 wt. % of trioctylphosphine, there is a sharp decrease in transparency within the whole spectral range from 400-800 nm.

Especially, in the inventive use, the proportion of trioctylphosphine is selected within a range of 0.005-5 wt. %. This allows for setting the transparency within a very broad range.

Most preferably, the trioctylphosphine is used with a proportion of 0.005-0.85 wt. % with respect to the weight of the polyisocyanate composition. In this case, the transparency is maximized. Put differently, when using the trioctylphosphine with a proportion of 0.005-0.85 wt. %, the trioctylphosphine can be used to increase the transparency of the polyisocyanurate plastic obtainable by the catalytic trimerization.

Even more preferred, the trioctylphosphine is used with a proportion of is 0.1-0.85 wt. %, in particular 0.3-0.8 wt. %, further preferred 0.4-0.75 wt. %, especially 0.4-0.6 wt. %, with respect to the weight of the polyisocyanate composition. In this case, polyisocyanurate plastics with maximal transparencies as well as highly advantageous stabilities and mechanical properties are obtainable.

Further advantageous implementations of the invention are evident from the exemplary embodiments.

### BRIEF DESCRIPTION OF THE DRAWINGS

The drawings used to explain the embodiments show:

FIG. 1 The absorbance of polyisocyanurate plastics produced with different proportions of trioctylphosphine within the spectral range of 300-800 nm;

FIG. 2A cylindrical tablet with a diameter of 5 cm consisting of an inventive polyisocyanurate plastic.

### EXEMPLARY EMBODIMENTS

### Materials

For the experiments, the substances listed in Table 1 were used.

TABLE 1

| Substance | Product/Supplier |
|---|---|
| Hexamethylene diisocyanate | Desmodur ® N 3600; Covestro |
| triisocyanurate | |
| Trioctylphosphine (97%; catalyst) | Sigma Aldrich |
| Tributylphosphine (97%; catalyst) | Sigma Aldrich |
| Potassium acetate (≥99.0%) | Sigma Aldrich |

### Preparation of Samples

25 g of a hexamethylene diisocyanate triisocyanurate (Desmodur N 3600; Covestro) was added to a beaker of a speed mixer (SM) at room temperature.

Then the respective amount of catalyst (type and proportion depending on experiment; see below), was added and the mixture was flushed with N₂ in the beaker and closed. Subsequently the mixture was homogenized with the speed mixer operating at 2′500 rpm for 60 seconds.

Samples of the so produced mixtures were poured into molds or containers in order to produce polyisocyanurate plastics with the desired shape (films, tablets). For the UV measurements, the mixtures were introduced directly into UV cuvettes (Eppendorf® UVette) and cured therein.

### Optical Properties

For transparency measurements, samples of the so produced mixtures were filled and cured in a cuvette (Eppendorf® UVette). After 1 month, UV/Vis measurements were carried out with a spectrometer of type Cary 60 UV/Vis using Agilent Cary WinUV Version 5.0.0.1005 software. As background/blank sample an empty cuvette was measured.

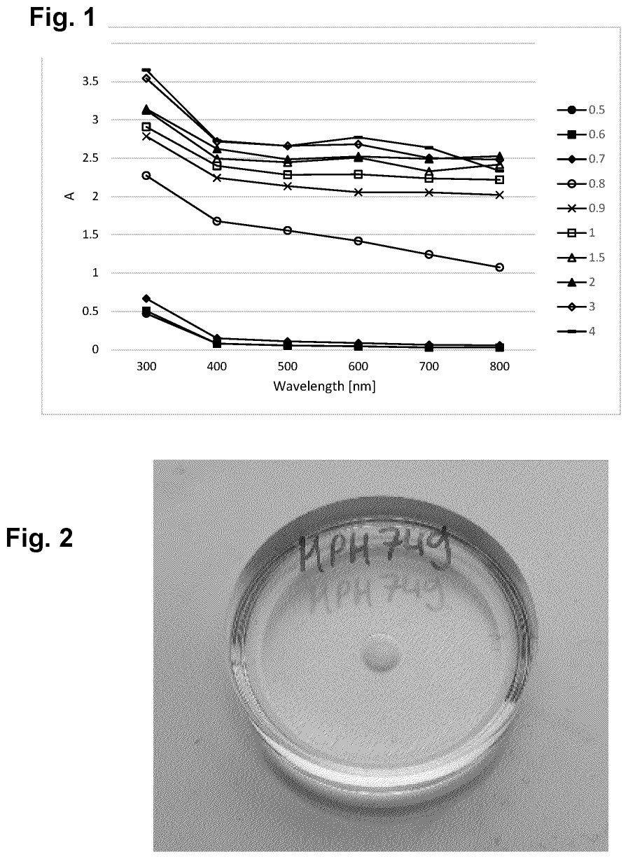

FIG. 1 shows the optical properties of a set of samples produced with different proportions of trioctylphosphine (catalyst) ranging from 0.5 to 4 wt. %. As evident, in the visible range from 400-800 nm, the absorbance (A) or the transparency, respectively, depends on the proportion of the trioctylphosphine. With proportions below 0.9 wt. %, highly transparent polyisocyanurate plastics can be obtained. This is in particular true for proportions of 0.5 wt. %, 0.6 wt. % and 0.7 wt. %. Thus, by adjusting the proportion of trioctylphosphine, the transparency of the polyisocyanurate plastics can be controlled.

For reasons of comparison, similar samples have been produced with tributylphosphine instead of trioctylphosphine. Thereby, proportions of tributylphosphine in the range of 0.5-4 wt. % hardly affect the transparency of the polyisocyanurate plastics. Thus, the transparency is essentially independent of the proportion of tributylphosphine. Furthermore, in contrast to trioctylphosphine, tributylphosphine is difficult to handle (spontaneous ignition in air, special personal protection equipment required, not very suitable for industrial production) and gives off a very bad smell.

FIG. 2 shows a cylindrical tablet consisting of an inventive polyisocyanurate plastic that was prepared with 0.5 wt. % trioctylphosphine. The tablet is completely blister-free and highly transparent for visible light.

### Mechanical and Thermal Properties

For testing mechanical and thermal properties, samples prepared as described above with 0.5 wt. % trioctylphosphine were used.

The tensile strength, elongation at break and the Young's modulus were determined according to DIN EN ISO 527 (tensile test speed: 10 mm/min) with cured films having a thickness of 2 mm (Dogbone sample type 5A, DIN EN ISO 527-2) Table 2 gives an overview of the results obtained.

TABLE 2

| | | Tensile | | |
|---|---|---|---|---|
| | Curing | strength | Elongation at | Modulus of |
| No. | (T, duration) | [MPa] | break [%] | elasticity [MPa]¹⁾ |
| A | RT, 7 d²⁾ | 15.1 | 36 | 770 |
| B | RT, 28 d²⁾ | 43.8 | 5.7 | 1′560 |
| C | RT, 28 d³⁾ | 42.9 | 4.2 | 1′520 |
| D | 80° C., 28 d⁴⁾ | 45.9 | 3.6 | 1′540 |
| E | 120° C., 28 d⁴⁾ | 37.7 | 3.0 | 1′540 |
| F | 160° C., 28 d⁴⁾ | 41.6 | 2.9 | 1′720 |

¹⁾at 0.05-0.25% elongation
²⁾under N₂ atmosphere
³⁾7 days under N₂ atmosphere and 21 days under air atmosphere
⁴⁾7 days at RT under N₂ atmosphere and 21 days at the given temperature under air atmosphere

As evident, after 28 d (28 days) of curing, rather high tensile strengths, elongations at break and Young's modulus are obtained. This at RT (room temperature, 23° C.) and at elevated temperatures, as well as under N₂ and under air atmosphere. Thus, the samples feature an excellent heat resistance at temperatures up to 160° C.

Furthermore, UV and color tests revealed high UV and color stability at temperatures up to 60° C. for 28 days for samples with 0.5 wt. % trioctylphosphine.

The refractive index of the samples with 0.5 wt. % trioctylphosphine were determined with laser test and found to be in the range of 1.52-1.56.

Scratch resistance tests (pencil hardness tests) of samples with 0.5 wt. % trioctylphosphine in the form of films of 500 μm thickness showed that the films are scratch resistant against pencils of type H.

Comparative Tests with Co-Catalysts

An additional test series was done to assess the influence of known co-catayst potassium acetate on the esthetic and optical properties of the compositions.

Three samples were produced using the following procedure:

13 g of a hexamethylene diisocyanate triisocyanurate (Desmodur N 3600; Covestro) was added to a beaker of a speed mixer (SM) at room temperature. Then the respective amount of catalyst (type and proportion depending on experiment; see below), was added under air atmosphere and the beaker and closed. Subsequently the mixture was homogenized with the speed mixer operating at 3′000 rpm for 60 seconds.

Sample S1 contained as catalyst 0.7 wt. % trioctylphosphine. This sample was immediately clear and transparent after mixing.

Sample S2 contained as catalyst 0.5 wt. % trioctylphosphine and 0.1 wt.-% potassium acetate (as 5 wt. % solution in polyethylene glycol PEG 400, of which 2.0 wt.-% were added to the composition). This sample was turbid right after mixing but cleared up gradually.

Sample S3 contained as catalyst 0.1 wt.-% potassium acetate (as 5 wt. % solution in polyethylene glycol PEG 400, of which 2.0 wt.-% were added to the composition). This sample was turbid right after mixing but cleared up gradually.

Samples S1-S3 were then subjected to different curing conditions (temperature) under air atmosphere. The cured samples were then assessed qualitatively by eye regarding appearance including bulk homogeneity, transparency and color in cured state, and surface quality (smoothness) in cured state.

The curing conditions and results of each experiment are summarized in Table 3.

TABLE 3

| | Curing | | | |
|---|---|---|---|---|
| Assess- | con- | | | |
| ment | ditions | S1 | S2 | S3 * |
| Appear- | RT, 3 d, | Clear, fully | Small bubbles | Large bubbles, |
| ance | open to air | transparent | in material, | slightly turbid, |
| | | and | slightly turbid, | colorless |
| | | colorless | colorless | |
| Surface | | Smooth | Rough with | Very rough |
| quality | | | ripples | with bubbles |
| | | | | and holes |
| Appear- | 100° C., | Clear, fully | Small bubbles | Large bubbles, |
| ance | 3 d, | transparent, | in material, | slightly turbid, |
| | open to air | slight | turbid, slight | slight |
| | | yellowing | yellowing | yellowing |
| Surface | | Smooth | Rough with | Very rough |
| quality | | | ripples | with bubbles |
| | | | | and holes on |
| | | | | surface |

* not according to the invention.

The results in Table 3 show that using trioctylphosphine as catalyst leads to very good transparency and flawlessly cured materials when cured under air both at ambient and hot temperatures. The addition of potassium acetate as co-catalyst (S2) and especially as sole catalyst (S3) leads to poorer transparency and negatively affects the esthetic quality of the cured material, both in bulk and on its surface, at least when the material is cured under air exposure.

It will be appreciated by those skilled in the art that the present invention can be implemented in other specific forms without departing from the spirit or essential characteristics thereof. The presently disclosed implementations and embodiments are therefore considered in all respects to be illustrative and not restricted.

1. Process for producing a polyisocyanurate plastic, comprising the following steps:
a) providing a polyisocyanate composition which comprises at least one oligomeric polyisocyanate,
b) adding at least one tertiary organic phosphine catalyst to the polyisocyanate composition,
c) catalytically trimerizing the isocyanate functionalities of the polyisocyanate composition using the at least one tertiary organic phosphine as trimerization catalyst,
whereby the at least one tertiary organic phosphine catalyst comprises trioctylphosphine and the at least one tertiary organic phosphine catalyst is used with a proportion of 0.005-0.85 wt. % with respect to the weight of the polyisocyanate composition.

2. Process according to claim 1, whereby the polyisocyanate composition has a content of monomeric isocyanates, of not more than 20 wt. %, based on the weight of the polyisocyanate composition.

3. The process according to claim 1, whereby the polyisocyanate composition provided in step a) comprises at least 80 wt. %, based on the weight of the polyisocyanate composition, of oligomeric polyisocyanates.

4. The process according to claim 1, whereby the at least one tertiary organic phosphine catalyst consists of trioctylphosphine and no further catalyst or co-catalyst other than trioctylphosphine is added in step b) and/or present in step c).

5. The process according to claim 1, whereby the proportion of the at least one tertiary organic phosphine catalyst, is 0.1-0.85 wt. %, with respect to the weight of the polyisocyanate composition.

6. The process according to claim 1, whereby the at least one oligomeric polyisocyanate has a uretdione, isocyanurate, allophanate, biuret, iminooxadiazinedione and/or oxadiazinetrione structure.

7. The process according to claim 1 wherein the at least one oligomeric polyisocyanate comprises one or more oligomeric polyisocyanates which are based on oligomers of 1,4-diisocyanatobutane, 1,5-diisocyanatopentane, 1,6-diisocyanatohexane, 2,2,4 (or 2,4,4)-trimethylhexane-1,6-diisocyanate, isophorone diisocyanate, 4,4′-diisocyanatodicyclohexylmethane or mixtures thereof.

8. The process according to claim 1, whereby
the proportion of the at least one tertiary organic phosphine catalyst is 0.4-0.8 wt. %, based on the weight of the polyisocyanate composition;
the polyisocyanate composition provided in step a) comprises at least 80 wt. %, based on the weight of the polyisocyanate composition, of oligomeric polyisocyanates;
the at least one oligomeric polyisocyanate comprises or consists of a trimer of 1,6-diisocyanatohexane; and
the polyisocyanate composition has a content of monomeric isocyanates, of less than 0.1 wt. %, based on the weight of the polyisocyanate composition.

9. The process according to claim 1, whereby the polyisocyanate composition and/or the oligomeric polyisocyanates have a mean NCO functionality of 2.0 to 5.0, and whereby the polyisocyanate composition has a content of isocyanate groups of 8-28 wt. %, based on the weight of the polyisocyanate composition.

10. The process according to claim 1, wherein process step b) is conducted at a temperature of 5-40° C., and/or at a relative air humidity of at least 20%.

11. The process according to claim 1, wherein the catalytic trimerization in step b) is conducted at least up to a conversion level at which at least 80%, of the isocyanate groups originally present in the polyisocyanate composition have been reacted.

12. Polyisocyanurate plastic obtainable by the process according to claim 1.

13. A coating, film, semi-finished product, optical component or molding or an adhesive comprising or consisting of a polyisocyanurate plastic according to claim 12.

14. A method comprising applying trioctylphosphine as a catalyst in a catalytic trimerization of a polyisocyanate composition, which comprises oligomeric polyisocyanates, and for controlling the optical transparency in the visible spectrum of a polyisocyanurate plastic obtainable by the catalytic trimerization.

15. The method according to claim 14 whereby the trioctylphosphine is used with a proportion of 0.005-0.85 wt. % with respect to the weight of the polyisocyanate composition.
